(19) United States
(12) Patent Application Publication
(10) Pub. No.: US 2018/0326576 A1
(43) Pub. Date: Nov. 15, 2018

(54) COUPLING DEVICE AND COUPLING METHOD

(71) Applicant: KUKA Deutschland GmbH, Augsburg (DE)

(72) Inventor: Martin RIEDEL, Augsburg (DE)

(21) Appl. No.: 15/777,404

(22) PCT Filed: Nov. 16, 2016
(86) PCT No.: PCT/EP2016/077807

§ 371 Date: May 18, 2018

(30) Foreign Application Priority Data
Nov. 19, 2015 (DE) 10 2015 120 058.9

(51) Int. Cl. B25J 9/00; B25J 5/00; B25J 19/02

(52) U.S. Cl. CPC B25J 9/0096; B25J 19/022; B25J 5/007

(57) ABSTRACT

A coupling device (8) and a method for coupling a mobile process apparatus (5) are provided. The device includes a programmable industrial robot (7) and a conveying device (6) conveying the industrial robot (7) to a workplace (2) in a process station (1). The coupling device (8) includes a clamping mechanism (9) including a clamping jaw and a clamping device (25). The clamping mechanism forms a clamping connection between the clamping jaw and a table leaf (3). The clamping connection fastens the process device (5) to the workplace (2).

### CROSS REFERENCE TO RELATED APPLICATIONS

This application is a United States National Phase Application of International Application PCT/EP2016/077807, filed Nov. 16, 2016, and claims the benefit of priority under 35 U.S.C. § 119 of German Application 10 2015 120 058.9, filed Nov. 19, 2015, the entire contents of which are incorporated herein by reference.

### FIELD OF THE INVENTION

The present invention pertains to a coupling device and to a coupling method which coupling device is intended and configured for coupling a mobile processing device with a programmable industrial robot and with a conveying device at a workplace of a processing station.

### BACKGROUND OF THE INVENTION

Such a coupling device is known from DE 20 2012 100 646 U1. It is configured as a positive-locking peg-out between the mobile carrying device of an industrial robot and a workpiece or a workplace. The carrying device is moved by the own motion of the industrial robot.

### SUMMARY OF THE INVENTION

An object of the present invention is to provide an improved coupling technique.

This object is accomplished by the present invention with a coupling technique claimed, i.e., the coupling device and the coupling method, have various advantages. The low weight and the energy efficiency resulting from it, the compact design with advantages for maneuverability and mobility as well as the preferably clamping coupling with advantages for rigidity and mechanical stability are to be emphasized.

The coupling technique being claimed offers an especially simple and universally applicable possibility for the clamping fixation of the mobile processing device and the programmable industrial robot thereof at a workplace at a processing station. The fixing clamped connection takes place at a clamping strip of the workplace. This may be a table leaf at the workplace, which is usually present anyway.

The mobile processing device can be coupled as needed at a plurality of different workplaces due to the coupling device. This is especially possible at manual workplaces with said table leaf. Due to the coupling and the clamping fixation, the industrial robot can be arranged at the edge of the table and very close to the process area of the workplace as well as approximately at the level of the table surface.

The coupling technique being claimed makes it possible to use compact industrial robots. These may be especially tactile industrial robots with an associated sensor system detecting external loads, whose tactile capabilities and sensory properties can be used for the process and, if needed, also during the travel of the mobile processing device, for detecting any possible obstacles.

The clamping device may have various configurations. It preferably has a plurality of parallel, horizontal clamping jaws, which are movable relative to one another and which flatly clamp between them the clamping strip and the table leaf The clamping device may also have a single upper or lower clamping jaw, which is pressed by the clamping unit against the top side or the underside of the clamping strip. The one clamping jaw or the plurality of clamping jaws is/are arranged vertically adjustably at the conveying device. The arrangement of the clamping point at a spaced location above the base on the table leaf has the advantage of offering a mechanically especially favorable fixing point. The forces of reaction occurring during the process, which are introduced by the industrial robot, can preferably be supported and absorbed over a broad surface on the table leaf.

An upper clamping jaw is configured, e.g., as a carrier for the industrial robot and has a robot connection, and a lower clamping jaw is configured as a pressure pad in the preferred embodiment. The clamping jaws are configured as bent sections overlapping one another, and the clamping unit is arranged between the clamping jaws. As a result, the clamping device can be adapted in a simple manner in relation to the respective given clamping strip or table leaf height.

At least one clamping jaw may be adaptable to the shape of the clamping strip or the table leaf, and, e.g., a support frame or the like on the underside of the table leaf may be overlapped and a contact of the clamping jaws ensuring clamping over a broad surface can be made possible on the top side and the underside of the table leaf.

The coupling device may have a positioning device for positioning the clamping device and/or the mobile processing device at the workplace. The positioning device preferably comprises mechanical and/or optical positioning units.

The conveying device is preferably configured as an automatic, self-propelled transport vehicle, which can steer itself and navigate independently. The conveying device can navigate during the travel and position itself accurately in relation to the work station with an optical positioning unit. Mechanical positioning units, e.g., index pins and mounting holes, may be used to accurately align and position the upper clamping jaw with the industrial robot in relation to the workplace. As a result, the industrial robot immediately has the necessary spatial reference in relation to the process area. Moreover, the safety can be increased and monitored during the driving mode.

The coupling device may have a sensor array for the detection of the correct clamping at the clamped strip or clamping strip or the table leaf As a result, incorrect positions of the upper clamping jaw with the industrial robot in the clamped position are avoided. Further, risks of accident can be detected and avoided. The detection device preferably has a sensor device, which extends circumferentially at the edge of the clamping jaw, which edge projects over the table leaf, and which sensor device is directed towards the surface of the strip or table. It can be determined hereby whether the upper clamping jaw is positioned sufficiently accurately and whether it overlaps the strip or table surface to the intended extent. Further, possible foreign objects can be detected and signaled in the area. The detection device may also include a measurement of the driving energy, especially of the motor currents. The different possible cases of error can be recognized with certainty, e.g., by a specific polling of the switching states of the sensor array combined with a measurement of the driving energy.

The coupling device may further have an energy coupling. This may be activated and deactivated, e.g., by the industrial robot. The mobile processing device has a carried-along energy storage device, e.g., an electric battery, and a conductive connection to an external energy supply unit at the workplace can be established with the energy coupling. The industrial robot may, for example, plug a carried-along power cable into a socket at the workplace for the energy coupling.

The processing device is preferably intended and configured for a human-robot cooperation or collaboration (HRC). This makes possible the use of the processing device at manual workplaces and in the immediate vicinity of a worker. As a result, the field of use of the mobile processing device and of the preferably tactile industrial robot thereof can be substantially expanded. In particular, great flexibility is possible due to coupling the processing device with many different and essentially any desired workplaces as needed.

The coupling device is an independent device. It may be an integral part of a mobile processing device and belong to the original equipment thereof. As an alternative, it may be used to retrofit or convert an existing processing device.

Further advantageous embodiments of the present invention are described in the subclaims.

The present invention is schematically shown as an example in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a view showing a processing station with a workplace and with a coupled mobile processing device as well as with the clamping device thereof;

FIG. 2 is a view showing one of different operating positions during the coupling of the clamping device with a table leaf of the workplace;

FIG. 3 is a view showing another of different operating positions during the coupling of the clamping device with a table leaf of the workplace;

FIG. 4 is a perspective view showing a processing station according to FIG. 1;

FIG. 5 is a perspective cut-away view showing a clamping jaw of the clamping device with a positioning and detection device;

FIG. 6 is a view showing a variant of the processing device and of the coupling thereof;

FIG. 7 is a view showing another variant of the processing device and of the coupling thereof;

FIG. 8 is a view showing another variant of the processing device and of the coupling thereof;

FIG. 9 is a view showing a functional diagram of a detection device;

FIG. 10 is a view showing a functional diagram of a detection device; and

FIG. 11 is a view showing an addition to the positioning device according to FIG. 5.

### DESCRIPTION OF THE PREFERRED EMBODIMENTS

Referring to the drawings, the present invention pertains to a coupling device (8) and to a coupling method. The present invention further pertains to a mobile processing device (5) with such a coupling device (8). Further, the present invention pertains to a processing station (1) with a workplace (2) and with a mobile processing device (5) with a coupling device (8).

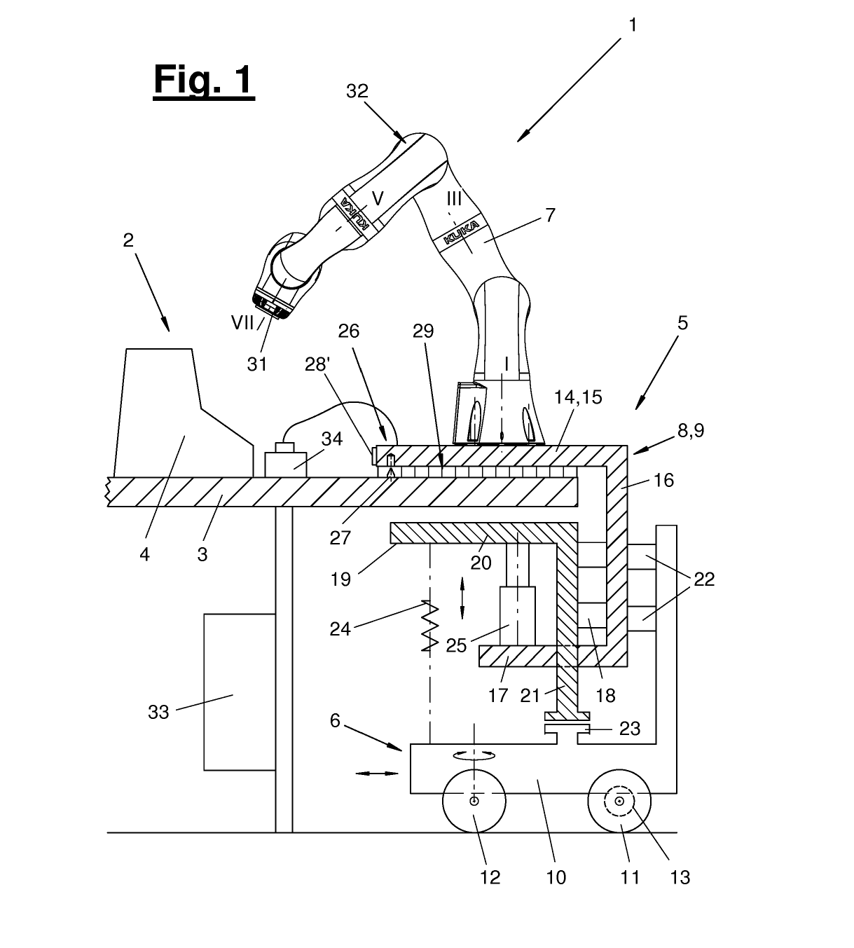

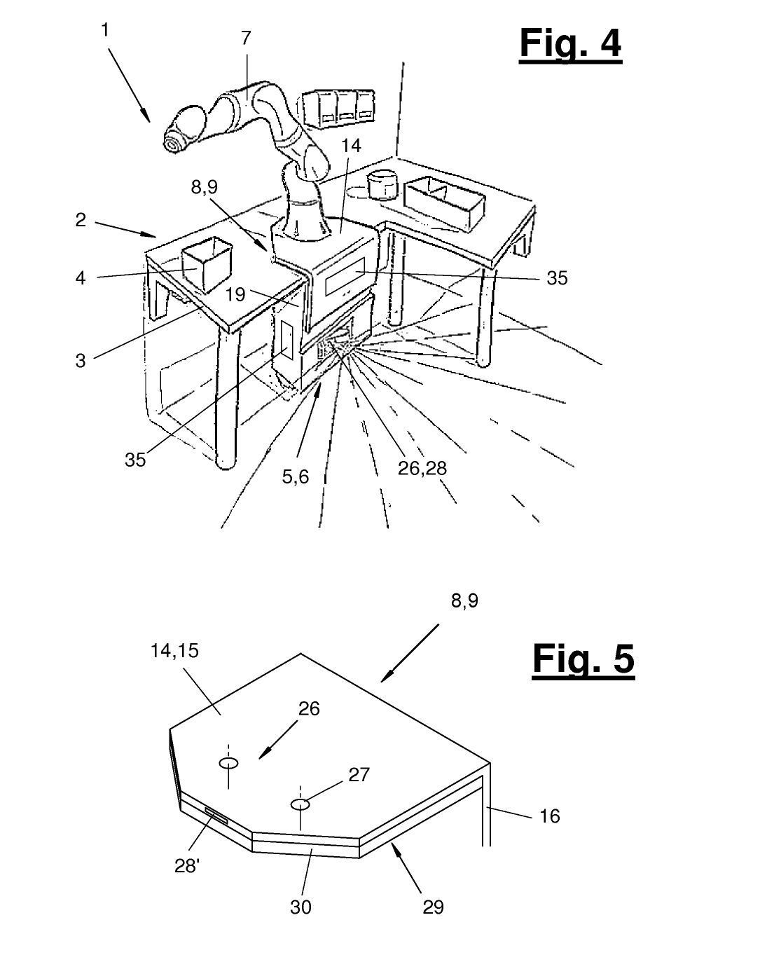

FIGS. 1 and 4 show a processing station with a workplace (2), at which a workbench with a table leaf (3) is stationarily arranged. A process area with a workpiece (4), on which any desired process, e.g., a joining or assembly process or a processing process or the like can be carried out, is located on the table leaf (3). The table leaf (3) is arranged at a spaced location from the base. The top side and the underside of the table leaf (3) are accessible from the free edge of the table. The table leaf (3) is supported on discrete and spaced-apart feet and/or by means of a wall bracket.

Said process may be carried out by a worker (not shown) or additionally or alternatively fully automatically or semi-automatically by means of a mobile processing device (5). The processing device (5) has a programmable industrial robot (7) and a conveying device (6) for the industrial robot (7). The industrial robot (7) may optionally be present as a plurality of industrial robots.

The conveying device (6) explained in more detail below is preferably floor-mounted and has a plurality of wheels (11, 12) as well as a controllable traveling mechanism and steering drive (13). It may travel in an omnidirectionally steerable manner on a base, e.g., the floor of a plant. It may navigate by means of a positioning device (26), especially an optical positioning unit (28), and move into the coupled position at the workplace (2), which position is shown in FIGS. 1 and 4.

The conveying device (6) shown is configured as a driverless, automatic, self-propelled and self-steering transport vehicle, e.g., as an FTF or AGV. Suitable driven units, e.g., Mecanum wheels, may be present for the omnidirectional mobility. As an alternative, the conveying device (6) may be configured as a driveless, manually movable transport vehicle.

The multilink industrial robot (7) has a plurality of robot axes (I-VII) and a robot control (not shown).

The industrial robot (7) is preferably configured as a tactile robot with an associated sensor system (32) for detecting externally acting mechanical loads. The industrial robot (7) is preferably arranged upright on the conveying device (6). As an alternative, it may be arranged suspended or in another position at the conveying device (6).

To couple the mobile processing device (5) with the workplace (2), a coupling device (8) is provided. This has, e.g., a clamping device (9). The controllable clamping device (9) has one clamping jaw or more, especially two clamping jaws (14, 19) and a clamping unit (25).

An upper clamping jaw (14) and another, lower clamping jaw (19) are present in the preferred embodiments. The clamping jaw(s) (14, 19) is/are configured as a plate in at least some areas.

The coupling device (8) may have, in addition, one or more controllable lateral coupling units (35), e.g., electromagnets, for alternative coupling to side walls of a workplace (2). A coupling unit (35) may be arranged, e.g., according to FIG. 4 at the conveying device (6) and/or at an upper clamping jaw (14).

The clamping device (9) is used to form a clamped connection fixing the processing device (5) at the workplace (2). The clamped connection is formed between a single clamping jaw (14, 19) or both clamping jaws (14, 19) and a clamping strip (or clamped strip) (3) at the workplace (2). The at least one clamping jaw (14, 19) is preferably oriented in parallel to the clamping strip (3), especially horizontally.

The clamping strip (3) is formed by the horizontal table leaf in the exemplary embodiment shown. The clamping point is located in the vicinity of said process area on the workbench. In another embodiment, the clamping strip (3) may be configured as a separate horizontal strip and arranged in a fixed manner at another location of the workplace (2), especially of the workbench, a wall or the like. The following description refers to a table leaf (3) and correspondingly also applies to other types of clamping strips.

The clamping device (9) may be intended and configured for attachment on the mobile processing device (5), especially on the conveying device (6). The clamping device (9) may further be intended and configured for receiving and supporting the industrial robot (7) or industrial robots. The clamping device (9) may be an integral part of the mobile processing device (5). It may be installed at the time of mounting the original equipment or for retrofitting or to replace and convert an existing coupling device.

The clamping device (9) may be movable in itself for clamping purposes and may have components that are movable relative to one another. In addition, it can be moved relative to the conveying device (6), especially relative to the base or chassis (10) thereof. The above-mentioned relative motions are preferably linear. As an alternative, they may be rotatory or combined linear/rotatory motions. The guides and drives for said relative motions are configured correspondingly.

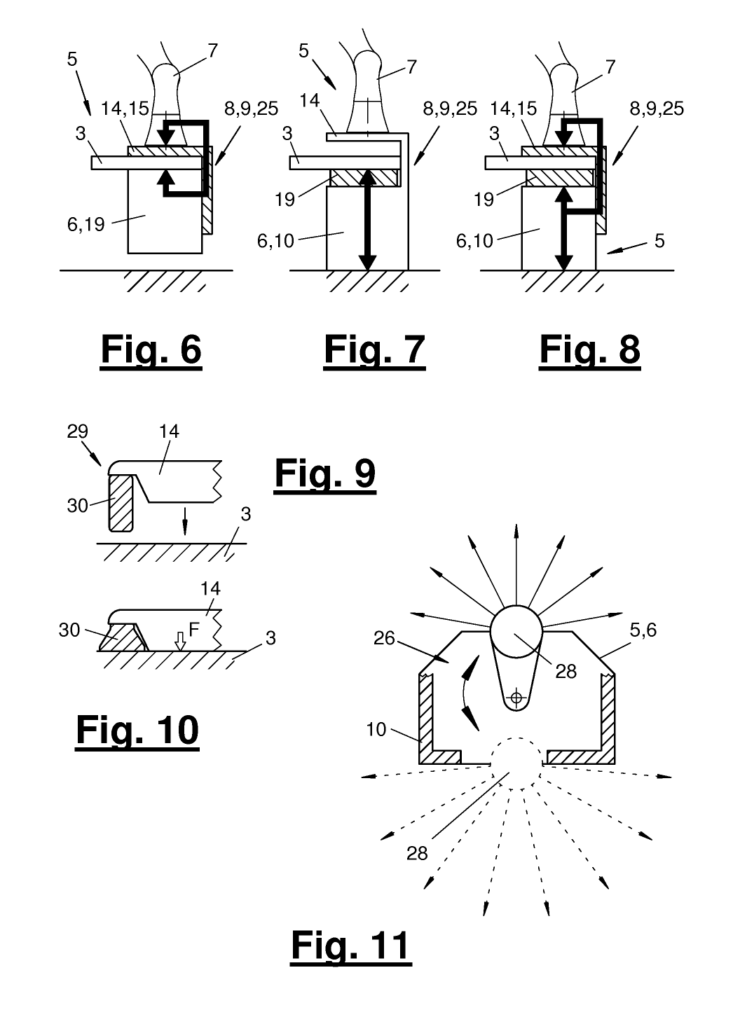

There are various possibilities for configuring the clamping device (9). FIGS. 1 through 3 show a preferred exemplary embodiment. Variants are shown in FIGS. 6 through 8.

In the exemplary embodiment according to FIGS. 1 through 3, the clamping device (9) has a plurality of, especially two parallel clamping jaws (14, 19), which are movable relative to one another and which clamp the clamping strip (3) between them. The clamping jaws (14, 19) are configured as bent sections overlapping one another, the clamping unit (25) being arranged between the clamping jaws (14, 19).

The clamping jaws (14, 19) are arranged at adjustable distance above the base and in the area of the table leaf (3) or the working level. The horizontal clamping jaws (14, 19) have a plate-like configuration in some areas and clamp the table leaf (3) there from the top and from the bottom as well as flatly between them.

The upper clamping jaw (14) is configured as a carrier for the industrial robot or industrial robots (9). It has a robot connection with a defined position for this. The lower clamping jaw (19) forms a pressure pad.

The upper clamping jaw (14) is configured with a C-shaped section. It has an upper horizontal leg (15), an upright leg (16) adjoining same on the rear side and, on the underside thereof, an adjoining second horizontal leg (17). The upper horizontal leg (15) forms said carrier with the robot connection on its top side.

The lower clamping jaw (19) has an L-shaped cross section and has a horizontal upper leg (20) and a downwardly directed upright leg (21) adjoining same. A stop, which acts against the conveying device (6), may be arranged at the lower end of the leg (21).

The two clamping jaws (14, 19) are mounted movably in relation to one another in the vertical direction. They overlap one another, the lower transverse leg (17) and the upright leg (21) passing through one another with an upright motion clearance. A guide (18) is arranged between the clamping jaws (14, 19), especially the upright legs (16, 21) thereof.

The clamping device (9), especially the upper clamping jaw (14), is mounted and guided vertically adjustably by means of an additional guide (22) at the conveying device (6), especially at the base or chassis (10) thereof. The lower clamping jaw (19) is carried during a vertical adjustment. As an alternative or in addition, it may also have a vertically adjustable mount and guide of its own at the base (10).

In the exemplary embodiment shown, the clamping unit (25) is arranged between the clamping jaws (14, 19), especially between the transverse or horizontal legs (17, 20) thereof. It has a controllable braking or blocking device. The clamping unit (25) can be withdrawn and extended in a controlled manner and is configured, e.g., as a fluidic, especially pneumatic cylinder. As an alternative, other design configurations, e.g., as a motor-driven spindle or toothed rack drive, as a pantograph or the like, are possible.

The clamping unit (25) may have a control of its own and/or be connected to a higher-level control of the mobile processing device (5). The clamping unit (25) may also have a self-locking configuration. It may further have an associated sensor system for detecting parameters, especially for displacement and/or force measurement.

A restoring unit (24), which moves the lower clamping jaw (19) against the stop (23) and into a starting position located there on deactivation of the clamping unit (25), acts on the lower clamping jaw (19) in the configuration shown. The vertically acting restoring unit (24), supported at the base (10), may be configured, e.g., as a spring and optionally have a damping. In another embodiment, it may be the own weight of the clamping jaw (19) or the force of gravity.

The starting position of the clamping jaws (14, 19) and the gap between the transverse legs (15, 20) thereof can be set and maintained by means of the clamping unit (25) and the restoring unit (24). The clamping device (9) can be pushed with this preset gap over the table leaf (3) from the front edge of the table leaf by a travel motion of the mobile processing device (5). To form the clamped connection, the clamping jaws (14, 19) are moved towards one another and away from the table leaf or the clamping strip (3).

The relative motions of the clamping device (9) may additionally be blocked in conformity with the situation, i.e., in the clamped position. This may be effected in any desired and suitable manner, e.g., by a brake or the like, at one guide or at a plurality of guides (18, 22). The mobile processing device (5), especially the conveying device (6), may be supported as a result at both the clamping strip (3) and the table as well as on the base. This may increase the rigidity and the positioning accuracy in the process.

FIG. 1 shows the starting position with the gap between the legs (15, 20) opened, wherein the legs overlap the edge area of the table leaf (3). The horizontal clamping surfaces for the clamped connection are arranged at the legs (15, 20).

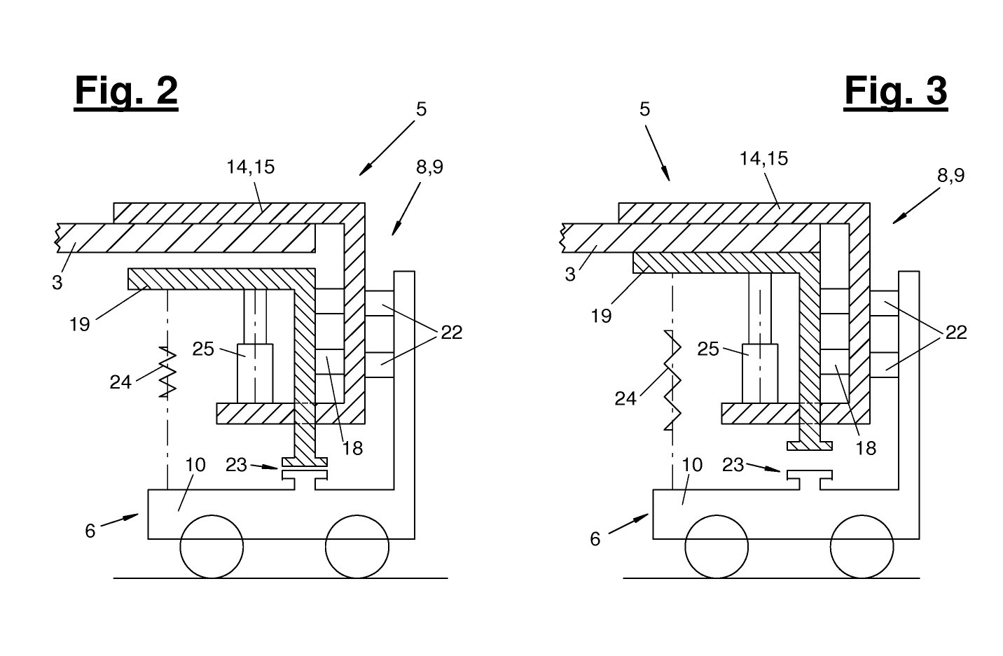

FIG. 2 shows the next operating position, in which the clamping unit (25) first lowers the upper clamping jaw (14) and brings the leg (15) thereof into contact with the top side of the table leaf (3). The lower clamping jaw (19) rests on the stop (23) and is held here by the restoring unit (24).

In the next operating position according to FIG. 3, the clamping unit (25) is extended and spreads out between the clamping jaws (14, 19), while the upper clamping jaw (14) is supported on the workbench (3) and the lower clamping jaw (19) is raised and is brought with its upper leg (20) into clamping contact with the underside of the table leaf (3). The contact with the stop (23) is abolished now and the restoring unit (24) is clamped. The clamping device (9) and the mobile processing device (5) are fixed and positioned at the table leaf (3) and at the workplace (2) in this clamped position.

At least one of the clamping jaws (14, 19), especially the transverse legs (15, 20) thereof, may be adapted to the shape of the clamping strip or table leaf (3). A secure clamped connection can be formed hereby especially for the lower clamping jaw (19) despite attachments, e.g., support arms, on the underside of the leaf or strip. The adaptation may be formed by inserts or other, preferably compression-proof adaptation units (not shown), which have openings for the attached parts.

The conveying device (6) has the aforementioned base (10), which may form a chassis and which has an upright wall or support for the guide (22) on the rear side. The base may have a shape tapered in the forward direction or an approximately triangular shape in the top view. Its width is greater than its length. The base (10) may have a body with a bottom and with one or more side walls.

The chassis is arranged on the base (10) with a plurality of wheels (11, 12). In the embodiment shown, there are three wheels (11, 12), which are arranged in an isosceles triangle in the top view. The rear parallel wheels (11) are flush with their rotation axes and have each an individually controllable drive unit of their own, e.g., an electric motor. Only one wheel (11) is visible in FIGS. 1 through 3 in the lateral view and when viewed in said width direction.

The front roller (12) is mounted, e.g., freely rotatably and may, moreover, pivot about a vertical axis indicated in FIG. 1. It forms a caster roller or steering roller and is located approximately in the center between the rear wheels (11).

The conveying device (6) has the aforementioned traveling mechanism and steering drive (13). These are formed, e.g., by the two individually controllable drive units of the wheels (11). The wheels (11) can be driven as a result in the same direction or in opposite directions and at equal or different speeds including a wheel stop. In case of rotation in the same direction at equal speed, there is a straight travel in the forward or reverse direction according to the arrow in FIG. 1. When a wheel is blocked and the other wheel (11) is rotating, turning takes place on the spot or with a very narrow turning radius. The same thing happens when the two wheels (11) are driven in opposite directions. When the two wheels (11) are driven in the same direction and at different speeds in relation to their common rotation axis, there is a travel along a curve with a curve radius dependent on the difference in speed in the forward or reverse direction.

The conveying device (6) can move in a very narrow space and in any desired direction due to the traveling mechanism and steering drive (13). The traveling mechanism and steering drive (13) may be provided with a control of its own and/or connected to a higher-level control of the mobile processing device (5).

The coupling device (8) has a positioning device (26) for positioning the clamping device (9) and/or the mobile processing device (5) at the workplace (2). The positioning device (26) may have one or more positioning units (27, 28). They may have any desired configuration. Mechanical positioning units (27) and optical positioning units (28) are used in the embodiment shown.

As is shown in FIGS. 1 and 2, the positioning device (26) is used to accurately position the upper clamping jaw (14) at the workbench (3). As a consequence, the industrial robot (7) will also be brought into an exact and predefined position at the workplace (2) and in relation to the process area thereof. The clamping jaw(s) (14, 19) can assume a lowered position during the travel of the conveying device (6). This lowers the center of gravity and improves the stability against tilting.

One or more mechanical positioning units (27) are used for exact positioning. These may comprise, e.g., pegs or pins on the top side of the table leaf (3) and fitting mounting holes on the underside of the clamping jaw (14), especially of the leg (15). The traveling mechanism and steering drive (13) may be switched off or switched on immediately for the purpose of positioning, so that tracking of the conveying device (6) is possible by the positioning units (27).

Another, and preferably optical positioning unit (28) may be arranged at the docking device (9) or at the conveying device (6). It may be configured, e.g., as an electronic camera and used to navigate the conveying device (6) during the travel and during the approach to and positioning at the workplace (2). The optical positioning unit (28) is configured, e.g., as a digital measuring camera, which detects and measures the surrounding area. As an alternative, it may be configured as a laser scanner or in another suitable manner. The optical positioning unit (28) can detect the relative position of the conveying device in relation to the surrounding area, especially the workbench and other objects at the workplace (2).

The positioning unit (28) may be present as a single unit or as a plurality of units. It is preferably located on the front and/or rear side of the conveying device (6). A single optical positioning unit (28) may be positioned, e.g., by means of a controllable adjusting device, optionally on the front or rear side. FIG. 11 schematically shows in a cut-away top view such an arrangement of an optical positioning unit (28), which arrangement is adjustable and especially pivotable between different functional positions, by the view of two functional positions drawn in solid and broken lines.

Another aspect of a cost-effective configuration pertains to this application of only one optical positioning unit (28), e.g., a laser scanner, according to FIG. 11, for navigation and safety purposes. By default, this laser scanner is oriented forward-looking with a field of vision of about 180° (according to the view drawn in solid lines). Should the mobile processing device (5) be unable to turn in a narrow space, as, for example, immediately after docking from a corner or during a front-side coupling operation, the laser scanner can be moved to another side, e.g., to the rear, in the structure frame of the conveying device (6) and, e.g., pivoted in the process. This position is indicated by broken lines. The laser scanner is suspended for this purpose movably, especially rotatably on a carrier, which can be fixed in both end positions with little vibration. The reduction of the structural rigidity of the conveying device (6) is irrelevant due to the clamping principle being used. In addition, the rearwardly directed laser scanner can be used to secure the working area of the industrial robot (7), especially against unauthorized access, and to detect the approach of persons to the processing device (5).

An optionally additional optical positioning unit (28′) may be used to position the clamping device (9), especially the upper clamping jaw (14), at the clamping strip (3). The aforementioned gap between the clamping jaws (14, 19) or the legs (15, 20) can also be set by means of this. The positioning unit (28′) indicated in FIGS. 1 and 5 is arranged in a suitable position, e.g., at the front end of the upper clamping jaw (14), and it detects the top side and/or the underside of the clamping strip (3) prior to the clamping. This may happen, e.g., during the approach to the workplace (2) or during the upward motion of the upper clamping jaw (14).

The coupling device (8) may further have a detection device (29). This may be used to detect correct clamping at the table leaf (3) and/or for accident prevention. A clamping jaw (14, 19) is pressed during the clamping against the clamping strip (3) with flat contact and with a greater clamping force.

According to FIGS. 1, 5, 9 and 10, the detection device (29) may have, e.g., a sensor array (30) located at the free edge area of the upper clamping jaw (14), especially of the leg (15) thereof The sensor array (30) may be arranged peripherally at this edge. It is located on the underside of the clamping jaw (14) and of the leg (15) and points towards the top side of the table leaf (3).

The sensor array (30) may be formed by, e.g., a plurality of contact sensors or pressure sensors, optionally with arrangement in a flexible tube. It detects whether foreign objects or body parts, which prevent contact between the clamping jaw (14) and the table leaf (3) over the entire area, are located in the clamping area. Different cases of error can thus be detected, in which, e.g., a foreign object or body part is located at the edge or in the inner or central area of the clamping jaw (14) or an excessively small segment of the table is clamped. In addition, a possible oblique position between the clamping jaw (14) and the table leaf (3), which is caused, e.g., by a large-area and one-sided clamping, can be detected. Said sensor-based detection may also be combined with a measurement of the occurring motor currents. A warning signal is sent when such errors or disturbances are detected and the clamping unit (25) is possibly stopped or reversed.

FIGS. 9 and 10 show a cut-away and sectional detail view of FIG. 5. The sensor array (30) is configured, e.g., as an elastic switching strip, which is recessed into the clamping jaw (14) on the underside thereof and at the edge area. The switching strip is compressed on contact with the table leaf (3) such that the clamping jaw (14) lies flat on the table surface and can transmit the forces F.

The positioning device (26) and/or the device (29) may be connected to a higher-level control of the mobile processing device (5) or of the clamping device (9).

The coupling device (8) may further have an energy coupling unit (34) arranged in FIG. 1. An energy connection can be established via this between an external, preferably electrical energy supply unit (33) at the workplace (2) and the mobile processing device (5) or the coupling device (8). The energy coupling unit (34) may be formed, e.g., from an energy line arranged and carried along at the processing device (5), especially a power cable, and a stationary energy terminal, i.e., a socket, at the workplace (2), especially at the table leaf (3). The programmable industrial robot (7) can activate and deactivate the energy coupling unit (34) by grasping, e.g., a plug at the energy line and plugging it into the energy supply unit and removing it again. The processing device (5), especially the conveying device (6) thereof, may have a carried-along energy storage unit, e.g., an electric battery (not shown), which is connected to the energy coupling unit (34).

FIGS. 6 through 8 show variants of the coupling device (8) and the clamping device (9) thereof The particular flow of the clamping force is indicated by arrows. The other components of the mobile processing device (5), especially the positioning device (26) and the detection device (29), may be configured in the same manner or in a similar, adapted manner as in the above-described exemplary embodiments.

FIG. 6 shows a simplified variant of a coupling device (8) and of the clamping device (9) thereof The clamping device (9) makes do with a single upper clamping jaw (14), which has, e.g., the bent L shape shown or another suitable shape. The pressure pad (19) may be formed by the conveying device (6), e.g., by the base (10) or the body thereof The clamping unit (25) acts between the clamping jaw (14) and the pressure pad (19) or the conveying device (6), and the clamping strip (3) is clamped between the carrier leg (15) and the pressure pad (19). When clamping and blocking, the conveying device (6) may optionally be raised. The clamping takes place from the top by the clamping jaw (14) with the carrier leg (15) moving over the table (3) and being subsequently lowered to the extent that it comes to lie on the table surface and is supported, while the conveying device (6) or the pressure pad (19) is pulled upward with the further clamping motion. Another type of prepositioning device may be present for the starting position of the clamping jaw (14) in this variant.

Only a lower clamping jaw (19) is present in the variant according to FIG. 7. The carrier (14) for the industrial robot (7) is rigidly connected to the conveying device (6) and is arranged at a sufficient distance above the top side of the table (3) and above the base (10). The lower clamping jaw (19) is arranged on the conveying device (6). It is acted on by the clamping unit (25) supported at the conveying device (6) and is raised for clamping at the table (3). The clamping is carried out in this variant from below, and a bracing takes place towards the floor.

FIG. 8 shows a third variant, which has similarities to the exemplary embodiment according to FIGS. 1 through 3. This variant has two clamping jaws (14, 19), which are supported and guided each at the conveying device (6) and are acted on by a common clamping unit (25) or by a separate clamping unit (25). The carrier leg (15) of the clamping jaw (14) is pulled downward against the top side of the table and the lower clamping jaw (19) is pressed upward against the underside of the table. The conveying device (6) stops on the floor, while the table leaf (3) is clamped on both sides.

The processing device (5) is intended and configured for a human-robot cooperation or collaboration (HRC). This may pertain to both the configuration of the industrial robot (7) and the configuration of the conveying device (6) and optionally also of the clamping device (9). Possible and unforeseen collisions with a worker can thus be detected. In addition, the driving forces or driving torques and the motion speeds of the mobile components of the processing device (5) and of the coupling device (8) or clamping device (9) can be limited to values suitable for HRC. As a result, injuries to the worker in case of a collision can be avoided. There also may be injury-free contacts with the worker.

The positioning device (26), especially the positioning unit (28′), makes it further possible to reduce the risk of crushing for the worker. The upper clamping jaw (14) may be positioned at a small and crushing-free vertical distance of, e.g., about 4 mm above the clamping strip (3) before the conveying device (6) moves the clamping device (9) over the clamping strip (3) or the workbench. A sensor-based force measurement at the clamping unit makes it possible to monitor the force and the risk of catching for the worker. Further, the sensor array (30) may point obliquely outwardly. As a result, it can detect a collision with the worker or with objects when running flatly over the clamping strip (3) or the workbench. The control can then trigger corresponding safety measures.

The industrial robot (7) shown in FIG. 1 is preferably configured as a tactile robot, which has sensory capabilities and which may optionally also be used in case of a human-robot collaboration (HRC).

The industrial robot (7) has a plurality of robot links and a plurality of driven robot axes (I-VII). It may have any desired number and configuration of translatory and/or rotatory robot axes. In the embodiment shown, the industrial robot (7) is configured as an articulated-arm robot and has seven rotatory robot axes (I-VII).

According to FIG. 1, the industrial robot (7) has a plurality of, e.g., three, four or more movable robot links connected to one another. The robot links are connected to one another and to a base in an articulated manner and via rotating robot axes (I-VII). The base is connected to the robot connection. It may have a connection for operating materials and may optionally accommodate the robot control. It is further possible for individual robot links to have a multipart configuration and to be movable in themselves, especially rotatable about the longitudinal axis.

The industrial robot (7) has at the end a driven link (31) with a preferably rotatable driven element, which is connected in the embodiment shown to a processing tool (not shown) directly or indirectly via a change coupling or media coupling. The last robot axis (VII) forms the rotating driven axis of the driven element. Operating materials can be supplied to the processing tool from a carried-long or external operating material supply unit internally via an inner line in hollow robot links and a media coupling. Operating materials may be, e.g., electric signal or power currents, compressed air, hydraulic fluid, coolant or the like.

The sensor system (32), with which mechanical loads acting from the outside, especially forces and/or torques, can be detected, is associated with the industrial robot (7). These may be especially reaction forces or reaction torques reacting from the process. The industrial robot receives said tactile properties and sensory capabilities via the sensor system (32). These may be used to search for the process point on the workpiece (4), for positioning the processing tool there and when carrying out the process as well as to control collisions during the travel.

The associated sensor system (32) is preferably integrated in the industrial robot (7), especially in the robot links thereof. The sensor system (32) may have one or more sensors, especially force sensors and/or torque sensors and optionally displacement or position sensors, which are preferably arranged at a mounting location and/or at a drive of a robot axis. In an alternative embodiment, the sensor system (32) may be arranged in another location, e.g., between the driven element and the processing tool.

The robot axes have each a journal bearing, especially a pivot bearing, and a controllable and optionally regulatable axis drive, e.g., rotating drive, which is associated and integrated here. Further, the axes may have a controllable or switchable brake, e.g., for the driving mode, and the optionally redundant sensor system (32), for detecting mechanical loads acting from the outside.

The industrial robot (7) may have one or more force-regulated or force- and position-regulated robot axes or axis drives. It may further have a flexibility regulation, which allows it to yield or elastically yield when an overload threshold is exceeded. Said force control or force regulation of the axes pertains to the action to the outside at the driven element of the driven link (31) as well as to the forces of reaction acting there. A torque control or torque regulation takes place within the robot at the robot axes or axis drives.

The tactile industrial robot (7) may have different modes of operation with different rigidities or flexibilities of its robot axes. This may be, e.g., a hand-guiding mode, a positioning or searching mode and a rigidity mode. Switching over is possible, if needed, between the modes of operation.

The preferred tactile industrial robot (7) is intended and configured suitably for an HRC. Its one or more flexible robot axes avoid accidents with a worker and crashes with objects in the working area due to force limitation and optionally stopping or elastic yielding in case of unforeseen collisions. The tactile industrial robot (7) can be used as a result for HRC in case of partial automation. It can respond to a tactile contact with the human body while avoiding injuries. Painless contacts may also occur in the process.

The tactile industrial robot (7) may be configured as a lightweight robot and consist of lightweight materials, e.g., light metals and plastic. It also has a small size. Moreover, it can have a low carrying force of, e.g., 5 kg to 20 kg. The processing tool likewise has a low weight.

Different variants of the embodiments shown and described are possible. In particular, the features of the different exemplary embodiments and of the variants may be combined with one another as desired and especially also transposed.

The clamping device (9) may make do with a single upper clamping jaw (14), in which case the clamping unit (25) presses, e.g., from below against the table leaf (3) or another clamping strip. Another type of prepositioning device may be present here for the starting position of the clamping jaw (14). The conveying device (6) may optionally also be raised during clamping and blocking.

The detection device (29) may have one or more detection units, which are coupled, e.g., with the positioning device (26) or with a positioning unit (27, 28). For example, a switching strip may be located in the positioning opening in case of a mechanical positioning unit (27). Further, the sensors of the sensor array (30) may be configured differently, e.g., as proximity or contact switches or the like.

The design configuration of the one or more clamping jaws (14, 19) and the guide(s) (18, 22) thereof is variable as well. This is true of the configuration and the arrangement of the clamping unit (25). This may also be present as a plurality of clamping units, in which case, e.g., each clamping jaw (14, 19) has a clamping unit of its own. A clamping unit (25) may, moreover, be at the conveying device (6), especially the base (10).

The chassis may have a different configuration. It may have, e.g., a front roller (12) steerable in a controlled manner with a steering drive and rear driving rollers (11) with shared traveling mechanism.

If the table leaf (3) has an upright lateral cover surface, this may be used by the mobile processing device (5) being pulled onto the workplace (2) via one or more coupling units (35), e.g., electromagnets, on different sides. For example, arrangement in a corner or at an end face is possible now. The lateral surfaces of the workplace (2) may consist of an iron-containing material, which may optionally also used for retrofitting on the spot. The upper, vertically adjustable clamping jaw (14) may have a coupling unit (35) on the rear side and thus be coupled flush with the table leaf (3).

The coupling device (8) with the industrial robot (7) may be permanently or replaceably connected to the conveying device (6). This makes possible pick-up and delivery services, e.g., by a carrier.

While specific embodiments of the invention have been shown and described in detail to illustrate the application of the principles of the invention, it will be understood that the invention may be embodied otherwise without departing from such principles.

1. A coupling device, which is intended and configured for coupling a mobile processing device with programmable industrial robot and with a conveying device at a workplace of a processing station, the coupling device comprising a clamping device comprising a clamping strip engagable clamping jaw and a clamping unit acting on the clamping strip engagable clamping jaw, wherein the clamping device is intended and configured to form a clamped connection between the clamping jaw and a clamping strip, at the workplace, which clamped connection fixes the processing device at the workplace.

2. A coupling device in accordance with claim 1, wherein the table leaf clamping jaw of the clamping device comprises a single upper or lower clamping jaw, which is pressed by the clamping unit against the side or the underside of the clamping strip, or the clamping device comprises a two upper clamping jaws or two lower clamping jaws, which are pressed by the clamping unit against the top side and the underside of the clamping strip.

3. A coupling device in accordance with claim 2, wherein the clamping jaw is or the clamping jaws are arranged at a spaced location above a base in an area of a table leaf at the workplace.

4. A coupling device in accordance with claim 2, wherein the clamping jaw is or the clamping jaws are arranged at a base or a chassis of the conveying device in a vertically adjustable manner.

5. A coupling device in accordance with claim 1, further comprising a carrier for carrying the industrial robot and a robot connection, wherein the carrier is configured rigidly or as a movable upper clamping jaw of the clamping strip engagable clamping jaw.

6. A coupling device in accordance with claim 2, wherein the clamping jaws are configured as bent portions, with each bent portion having a mutually overlapping section and the clamping unit is arranged between the clamping jaws.

7. A coupling device in accordance with claim 1, further comprising one or more guides for the clamping jaw or clamping jaws, which guides are connectable to the mobile processing device.

8. A coupling device in accordance with claim 1, further comprising a positioning device, which is intended and configured for positioning the clamping device and/or the mobile processing device at the workplace and/or for securing a workplaces for the working area of the robot.

9. A coupling device in accordance with claim 8, wherein the positioning device comprises a rigidly arranged optical positioning unit comprising a laser scanner, and/or an optical positioning unit, which can be moved into a plurality of functional positions.

10. A coupling device in accordance with claim 1, further comprising a detection device for detecting correct clamping at the clamping strip.

11. A coupling device in accordance with claim 1, further comprising an energy coupling unit.

12. A mobile processing device comprising:
a programmable industrial robot;
a conveying device;
a coupling device for coupling at a workplace of a processing station, wherein workplace has a clamping strip the coupling device being intended and configured for coupling the programmable industrial robot and the conveying device at the workplace of the processing station, the coupling device comprising a clamping device comprising a clamping strip engagable clamping jaw and a clamping unit acting on the clamping strip engagable clamping jaw, wherein the clamping device is intended and configured to form a clamped connection between the clamping jaw and a clamping strip at the workplace, which clamped connection fixes the processing device at the workplace.

13. A mobile processing device in accordance with claim 12, wherein the industrial robot is configured as a tactile robot with an associated integrated sensor system detecting external loads.

14. A mobile processing device in accordance with claim 12, wherein the conveying device has a movable base with a guide and with a stop for the clamping device.

15. A mobile processing device in accordance with claim 12, wherein the conveying device is configured as a driverless, automatic transport vehicle with a controllable traveling mechanism and steering drive.

16. A method for coupling a mobile processing device with a programmable industrial robot and with a conveying device at a workplace of a processing station, the method comprising:
providing a clamping strip at the workplace;
coupling with a clamping device comprising a horizontal clamping strip engagable clamping jaw and a clamping unit at the mobile processing device and with the clamping strip at the workplace, wherein a fixing clamped connection is formed between the clamping jaw and the clamping strip.

17. A method in accordance with claim 16, wherein a single upper or lower clamping jaw is pressed against the top side or the underside of the clamping strip or a plurality of upper or lower clamping jaws are pressed against the top side and the underside of the clamping strip.

18. A method in accordance with claim 16, wherein the clamping jaw is pressed with flat contact against the clamping strip, and correct clamping and possible disturbances related to a presence of foreign objects or body parts in the clamping area, are detected with a detection device.

19. A method in accordance with claim 16, wherein the clamping device and/or the mobile processing device are positioned at the workplace and/or the working area of the industrial robot is secured at the workplace by means of a positioning device.

20. A method in accordance with claim 16, wherein an optical positioning unit, which can be moved into a plurality of functional positions is used for navigation and safety purposes.
